(19) United States
(12) Patent Application Publication
(10) Pub. No.: US 2018/0304790 A1
(43) Pub. Date: Oct. 25, 2018

(54) VEHICLE CONSOLE WITH AN ADJUSTABLE ARMREST

(71) Applicant: Ford Global Technologies, LLC, Dearborn, MI (US)

(72) Inventors: Babugouda Patil, Koln (DE); Thomas Beyer, Koln (DE); Stefan Reger, Leverkusen (DE)

(73) Assignee: Ford Global Technologies, LLC, Dearborn, MI (US)

(21) Appl. No.: 15/921,780

(22) Filed: Mar. 15, 2018

(30) Foreign Application Priority Data
Apr. 21, 2017 (DE) 102017206720.9

(51) Int. Cl. B60N 2/75; B60R 7/04

(52) U.S. Cl. CPC B60N 2/793; B60R 2011/0007; B60R 7/04; B60N 2/773

(57) ABSTRACT

A vehicle console includes a console body defining a storage compartment accessible through an upper opening and an adjustable armrest held displaceably on a basic body mounted pivotably on the console body and between first and pivoting positions. A guide in the form of a one-sided guide rail provided in the upper part of the console body extending in a longitudinal direction of the opening. A locking element guided on one side of the rail is displaceable together with the armrest along the basic body, protrudes out of the armrest, and is retractable into the armrest by an actuating mechanism. The guide is arranged on an inner side of the storage compartment in the console body, and, in the first pivoting position, the at least one locking element, in its position protruding from the armrest, is guided in a sliding manner on the inner side of the storage compartment.

### FIELD OF THE INVENTION

The present invention generally relates to storage consoles in vehicles, and more particularly relates to a vehicle console with an adjustable armrest.

### BACKGROUND OF THE INVENTION

Vehicle storage consoles are commonly employed in many vehicles. The center console is generally arranged between a driver's seat and a front passenger's seat of a passenger vehicle. For example, U.S. Pat. No. 7,770,953 B2 discloses a vehicle console with an adjustable armrest which has an actuating lever which is mounted at its front end and via the actuation of which a storage compartment accommodated in a console body can be opened and closed by pivoting of the armrest, and also the armrest can be adjusted in the horizontal direction for adaptation to different drivers of the vehicle. In order to guide the armrest during the adjustment in the horizontal direction, an upper part on both longitudinal sides of the console body are provided with outwardly opening guide grooves in which corresponding locking pins held in the armrest engage from the outside and are guided in a sliding manner. By actuation of the actuating lever, the locking pins can be brought out of the form-fitting engagement with the respective guide groove, and therefore the armrest can be pivoted and opens up an opening of the storage compartment. Since the locking pins held in the armrest engage in the guide grooves from the outside, the armrest has to be configured to be significantly wider than the console body in order to be able to position the locking pins from the outside. Furthermore, the lower side of the armrest has an incision running in the longitudinal direction of the guide grooves in order to be able to accommodate the upper part, having the guide grooves, of the console body therein when the storage compartment is closed by the armrest. This may result in a fractured lower side of the armrest caused by the incisions and leads and a guide or locking mechanism that is visible in substantial parts.

Furthermore, U.S. Pat. No. 6,932,402 B2 describes a vehicle console with an adjustable armrest, wherein two additional side walls are arranged on a console body, in which a storage compartment is accommodated, on each side wall of the console body, the additional side walls projecting over an upper part of the console body and being introduced into the inwardly opening guide grooves. Guide pins held on the armrest engage in a sliding manner in the guide grooves, and therefore the armrest is displaceable in the longitudinal direction of the vehicle.

An armrest of a vehicle console that is mounted in a longitudinally adjustable manner on a console body is furthermore disclosed in U.S. Patent Application Publication No. 2013/0153447 A1. The adjustment mechanism comprises at least one guide rod on which the armrest is guided in the longitudinal direction.

It would be desirable to provide for an improved vehicle console with an adjustable armrest which is intended to be able to be produced cost-effectively.

### SUMMARY OF THE INVENTION

According to one aspect of the present invention, a vehicle console is provided. The vehicle console includes a console body defining a storage compartment which is accessible through an opening in an upper part of the console body, and an armrest held displaceably on a basic body which is mounted pivotably on the console body to be pivotable between a first pivoting position, in which the basic body extends along the opening, and a second pivoting position, in which the basic body is inclined with respect to the opening. The vehicle console also includes at least one guide provided in the upper part of the console body extending in a longitudinal direction of the opening, and at least one locking element which is displaceable together with the armrest along the basic body, protrudes out of the armrest and is retractable into the armrest by an actuating mechanism arranged on the armrest, wherein the at least one guide is arranged on an inner side of the storage compartment in the console body, and, in the first pivoting position of the basic body, the at least one locking element, in its position protruding from the armrest, is guided in a sliding manner on the inner side of the storage compartment in the longitudinal direction of the opening by the guide, wherein the at least one guide is designed as a one-sided guide rail on the upper part of the console body, on which the at least one locking element is guided only on one side.

According to another aspect of the present invention, a vehicle console is provided. The vehicle console includes a console body defining a storage compartment and an upper opening, an armrest held displaceably on a basic body which pivots on the console body between first and second pivoting positions, a guide provided in an upper part of the console body, and a locking element displaceable together with the armrest along the basic body to protrude out and retract into the armrest by an actuating mechanism.

According to a further aspect of the present invention, a vehicle console is provided. The vehicle console includes a console body defining a storage compartment and an upper opening, an armrest held displaceably on a basic body which pivots on the console body between first and second pivoting positions, a one-sided guide rail provided on an upper part of the console body, and a locking element displaceable together with the armrest along the basic body, and guided only on one side of the guide rail.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective side view of an exemplary embodiment of a vehicle console with a console body and an adjustable armrest in a closed state, according to one embodiment;

FIG. 2 is a perspective side view of the vehicle console from FIG. 1 in an open state;

FIG. 3 is a perspective side view of the vehicle console from FIG. 1 in an open state, wherein the armrest is in a pushed-out position;

FIG. 4 is a perspective side view of the armrest of the vehicle console from FIG. 1 in a pushed-back position;

FIG. 5 is a perspective side view of the armrest of the vehicle console from FIG. 1 in a pushed-out position;

FIG. 6 is a perspective top view of the armrest from FIG. 5;

FIG. 7 is a perspective bottom view of the armrest from FIG. 5;

FIG. 8 is a bottom view of the armrest from FIG. 4;

FIG. 9 is a top view of the armrest from FIG. 4;

FIG. 10 is a cross-sectional view of the armrest from FIG. 8 along the intersecting line X-X shown in FIG. 8;

FIG. 11 is a cross-sectional view of the armrest from FIG. 9 along the intersecting line Y-Y shown in FIG. 9;

FIG. 12 is a sectioned top view of the actuating mechanism of the armrest shown in FIG. 9; and

FIG. 13 is an exploded view of the actuating mechanism shown in FIG. 12.

### DETAILED DESCRIPTION OF THE PREFERRED EMBODIMENTS

In the various figures, parts which are equivalent in respect of their function are always provided with the same reference signs, and therefore the parts are generally also only described once.

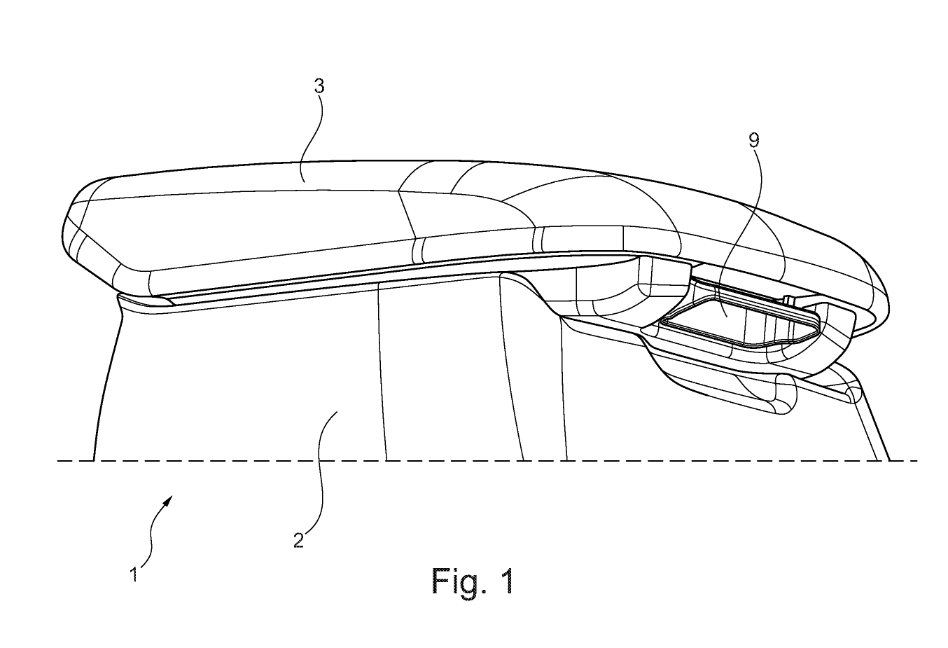

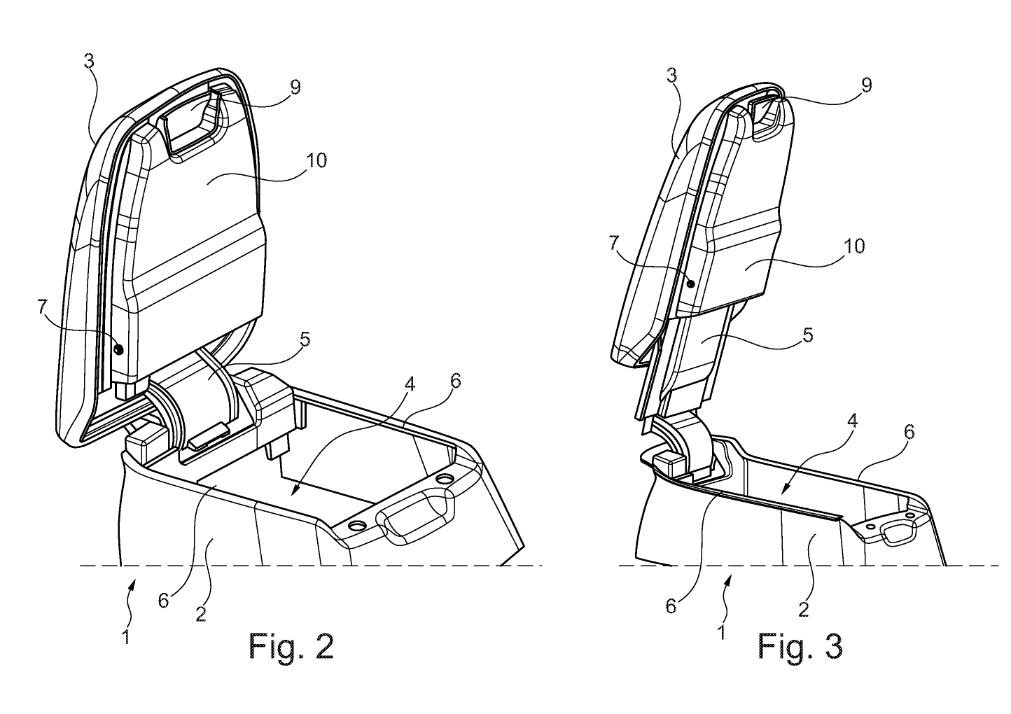

FIG. 1 illustrates a perspective side view of an exemplary embodiment of a vehicle console 1 with a console body 2 and an adjustable armrest 3 in a closed state. In the closed state, the armrest 3 conceals an opening of a storage compartment 4 accommodated in the console body 2 (see FIG. 2). The vehicle console 1 illustrated in FIG. 1 is a center console which is arranged between a driver's seat and a front passenger's seat of a motor vehicle (not illustrated).

FIG. 2 illustrates a perspective side view of the vehicle console 1 from FIG. 1 in an open state. In the open state, the access to the storage compartment 4 of the console body 2 is opened up through a corresponding opening in an upper part of the console body 2. FIG. 3 illustrates a perspective side view of the vehicle console 1 from FIG. 1 in an open state, wherein the armrest 3 is in a pushed-out position in comparison to the illustration in FIG. 2.

It can be gathered from FIGS. 2 and 3 that the armrest 3 is held on a basic body 5 in a longitudinally displaceable manner. As can furthermore be seen, the basic body 5 in turn is mounted pivotably on the console body 2, and therefore the basic body 5 is pivotable between a first pivoting position, in which the basic body 5 extends along the opening of the storage compartment 4, as illustrated in FIG. 1, and a second pivoting position, in which the basic body 5 extends in an inclined manner with respect to the opening of the storage compartment 4, as illustrated in FIGS. 2 and 3.

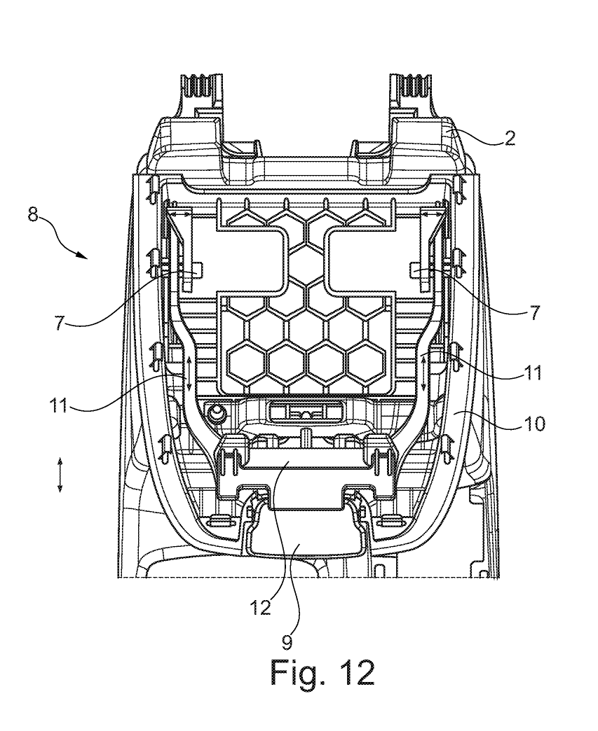

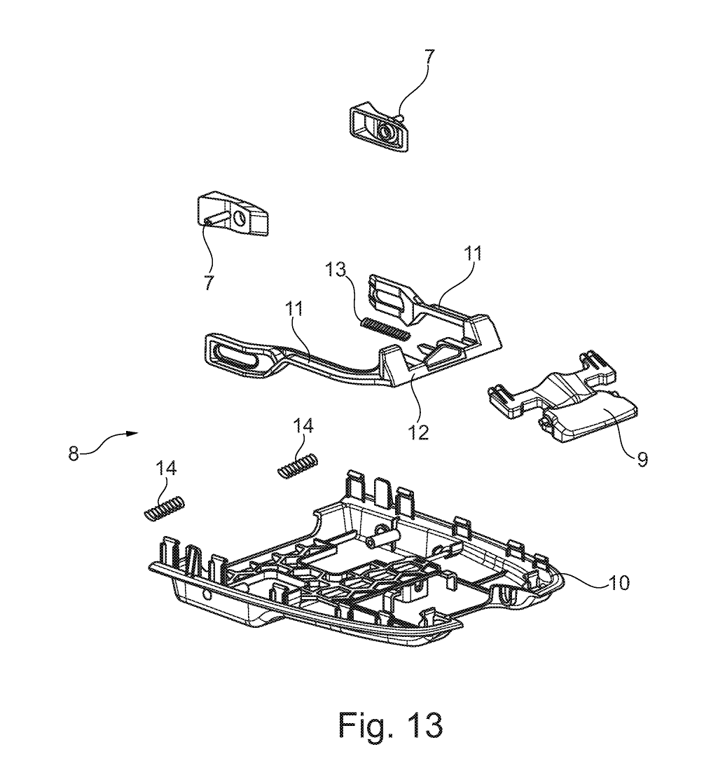

As can be seen in FIGS. 2 and 3, in the case of the exemplary embodiment of the vehicle console 1 which is shown, on each side wall of the storage compartment 4, which side wall is formed by the console body 2, at least one guide 6 is provided in the upper part of the console body 2 in the form of a one-sided guide rail which is designed in the form of a flange and extends in a longitudinal direction of the opening of the storage compartment 4. In particular, in the case of the exemplary embodiment which is shown of the vehicle console 1, the guide 6 in the form of two guide rails is or are formed integrally with the console body 2, for example is or are injection molded thereon and produced from plastic. In a manner corresponding to the two guides 6, a locking element 7 which is displaceable together with the armrest 3 along the basic body 5, protrudes from the armrest 3 and is in the form of a locking pin 7 is respectively provided for each guide rail 6 on the armrest 3. The locking pin 7 on both sides of the armrest 3 is retractable by an actuating mechanism 8 arranged on the armrest 3 (see FIGS. 12 and 13).

Of the actuating mechanism 8, only an actuating lever 9 which is mounted on the armrest 3 so as to be rotatable between a non-actuating position and an actuating position can be seen in FIGS. 1, 2 and 3. Otherwise, the actuating mechanism 8 is completely accommodated in a housing 10 arranged on a lower side of the armrest 3, the lower side facing the opening of the storage compartment 4. As can furthermore be gathered from FIGS. 2 and 3, the lower side of the housing 10, particularly the lower side facing the opening of the storage compartment 4, is substantially smooth, that is to say is formed without fractures, incisions and the like.

It can furthermore be gathered from FIGS. 2 and 3 that the one-sided guide rails 6 running in the longitudinal direction of the storage compartment 4 on both longitudinal sides of the console body 2 are each arranged on an inner side of the storage compartment 4 in the console body 2. In the first pivoting position of the basic body 5 that is shown in FIG. 1, the two locking elements 7, which are held on both sides on the armrest 3, in their position protruding from the armrest 3, are guided on the guides 6, particularly the guide rails in a manner sliding on one side on the inner side of the storage compartment 4 in the longitudinal direction of the opening of the storage compartment 4 by the guide 6.

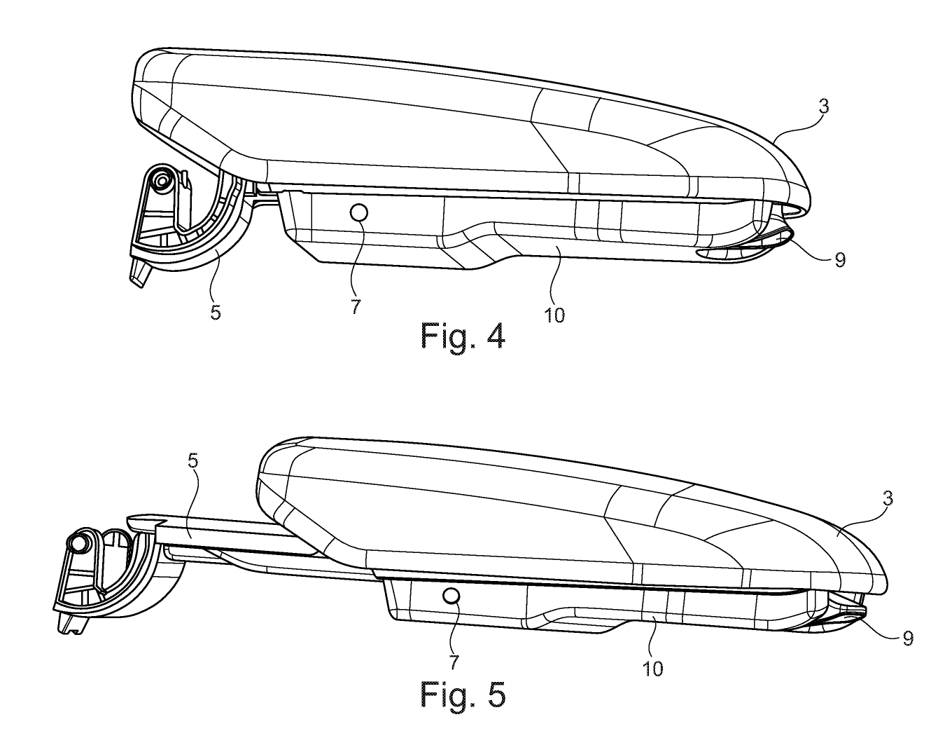

FIG. 4 illustrates a perspective side view of the armrest 3 of the vehicle console 1 from FIG. 1 in a pushed-back position. FIG. 5 illustrates a perspective side view of the armrest 3 of the vehicle console 1 from FIG. 1 in a pushed-out position. It can clearly be seen that the armrest 3 together with the actuating mechanism 8 accommodated in the housing 10 (see FIGS. 12 and 13) including the actuating lever 9 and the locking elements 7 is held on the basic body 5 in a longitudinally displaceable manner. In the exemplary embodiment of the armrest 3 shown, the extent of the maximum longitudinal displacement is approximately 95 mm, wherein the amount is of course intended to be mentioned merely by way of example. Since the actuating mechanism 8 together with the actuating lever 9 is always displaced together with the armrest 3 along the basic body 5, the actuating lever 9 can very easily be found and operated as intended by a user in any desired position of the armrest 3.

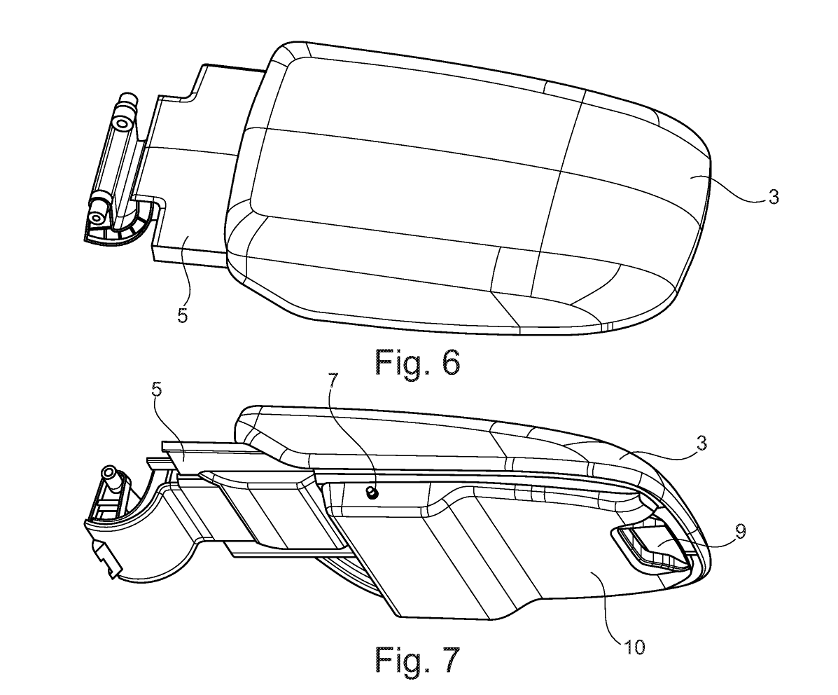

FIG. 6 illustrates a perspective top view of the armrest 3 from FIG. 5, and FIG. 7 illustrates a perspective lower view of the armrest 3 from FIG. 5. It can readily be seen in FIGS. 6 and 7 that, in addition to the pivotable connection of the armrest 3 to the console body 2 and the longitudinally displaceable mounting of the armrest 3, the basic body 5 also carries out the further function of completely covering the rear region which has become free during the forwardly directed longitudinal displacement of the armrest 3, and therefore the storage compartment 4 which is arranged below the armrest 3 is not opened up by the longitudinal displacement of the armrest 3 in the closed state of the vehicle console 1.

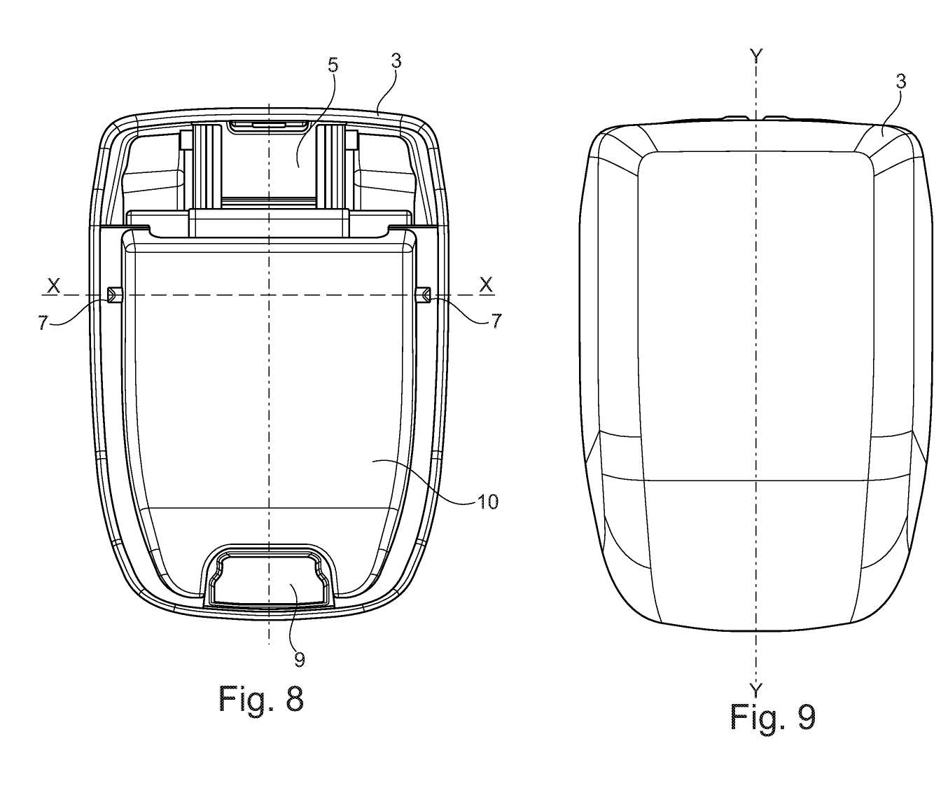

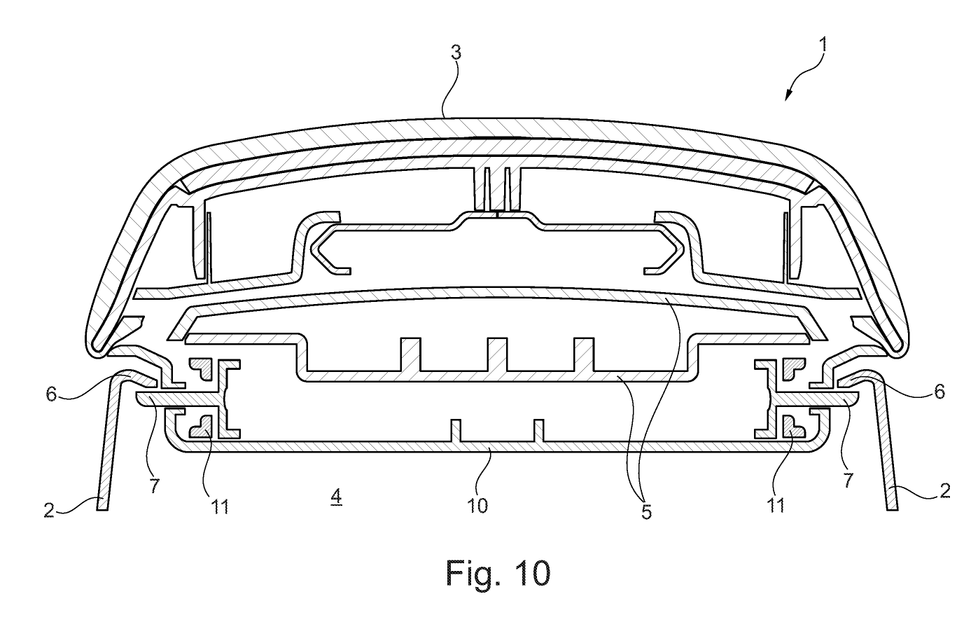

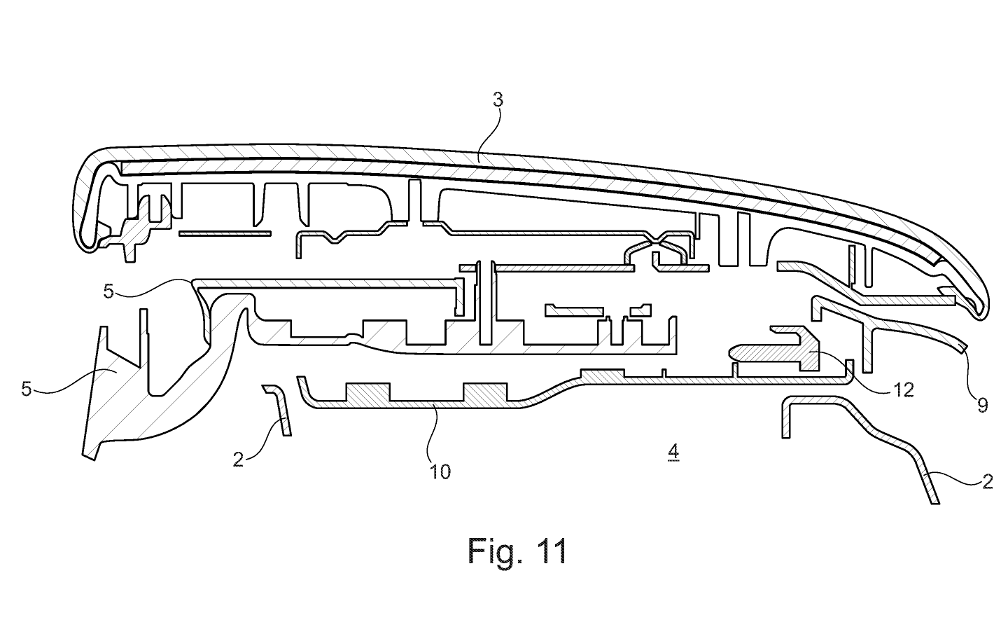

FIG. 8 illustrates a lower view of the armrest 3 from FIG. 4, and FIG. 9 illustrates a top view of the armrest 3 from FIG. 4. FIG. 10 illustrates a cross-sectional view of the armrest 3 from FIG. 8 along the intersecting line X-X shown in FIG. 8, and FIG. 11 illustrates a cross-sectional view of the armrest 3 from FIG. 9 along the intersecting line Y-Y shown in FIG. 9.

In the view of the vehicle console 1 that is illustrated in FIG. 10 showing the armrest 3 in the first pivoting position of the basic body 5, the one-sided guides 6 or guide rails which are formed integrally with the console body 2 in the upper part thereof and on which a locking element 7 which is designed as a locking pin is guided merely on one side can clearly be seen. As can furthermore be gathered from FIG. 10, each guide 6 in the form of a guide rail of the exemplary embodiment shown of the vehicle console 1 is curved inward in the form of a flange on the upper edge of the console body 2 and is formed integrally therewith. This constitutes a mechanical guide of the locking elements 7 which can be realized particularly simply and also permits a tolerant joining accuracy of guide 6 and locking element 7. Furthermore, the guide 6 which is formed in the manner of a flange on the upper edge of the console body 2 advantageously results in stiffening of the console body 2, in particular on the upper part thereof.

In the first pivoting position of the basic body 5 that is illustrated in FIG. 10 (closed storage compartment 4), the armrest 3 is in addition prestressed elastically in the direction of the second pivoting position of the basic body 5 (open storage compartment 4). In the exemplary embodiment shown of the vehicle console 1, this is achieved by the elasticity of the materials forming the vehicle console 1, the materials being slightly compressed in the first pivoting position of the basic body 5.

In other words, in the closed state closing the storage compartment 4, the armrest 3 is pushed in the direction of the open position thereof (second pivoting position of the basic body 5), as a result of which the two locking elements 7 are always brought on their upper side into contact with the guide 6. This can advantageously significantly reduce a tendency of the vehicle console 1 to shake in the closed state. In addition, the armrest 3 is fixed as desired in its longitudinal position by the frictional force, which is produced by the contact force, between the locking element 7 and the guide 6. Only by overcoming the frictional force can the armrest 3 be adjusted in its longitudinal direction into a new position as desired along the guide 6. This considerably increases the operating comfort for the user of the vehicle console 1 and significantly reduces the structural outlay on the vehicle console 1.

In the cross-sectional view (illustrated in FIG. 11) of the armrest 3 from FIG. 9 along intersecting line Y-Y, the interaction of the actuating lever 9 with a component 12 of the actuating mechanism 8 described below (see FIGS. 12 and 13) can be seen.

FIG. 12 illustrates a sectioned top view of the actuating mechanism 8 of the armrest 3 from FIG. 9. As can be seen, the actuating mechanism 8 comprises the actuating lever 9 which is mounted on the armrest 3 so as to be rotatable between a non-actuating position and an actuating position, two locking struts 11 mounted in a longitudinally displaceable manner in the longitudinal direction of the armrest 3, and the transversely displaceable locking element 7 which is designed as a locking pin 7 in the transverse direction of the armrest 3. It can furthermore be gathered from FIG. 12 that the two locking struts 11 are connected to each other on the front side of the armrest 3, the front side facing the actuating lever 9, via a transverse strut 12. The actuating lever 9, during its rotation on the armrest 3, acts on the transverse strut 12 in such a manner that the transverse strut 12 and the locking struts 11 connected thereto are displaced longitudinally rearward, that is to say to the rear side of the armrest 3, the rear side facing away from the actuating lever 9, as is indicated in FIG. 12 by corresponding double arrows on the locking struts 11. The longitudinal displacement of the locking struts 11 rearward in turn causes the locking elements 7 to be transversely displaced inward, as is likewise indicated in FIG. 12 by corresponding double arrows on the locking pins 7, such that the locking elements 7 can be pulled back into the armrest 3 and therefore brought out of engagement with the guides 6.

The actuating lever 9 is preferably rotatable between its non-actuating position and the actuating position through approximately twenty-three degrees (23°). In this connection, the locking struts 11 are displaced rearward or forward at maximum by approximately ten millimeters (10 mm). As a result of the longitudinal displacement of the two locking struts 11, the two locking elements 7 move transversely with respect to the longitudinal direction of the armrest 3 by approximately five millimeters (5 mm). The material used for the actuating mechanism 8 is preferably a polyoxymethylene material (POM) to substantially avoid noise arising during the actuation of the actuating mechanism 8.

FIG. 13 illustrates an exploded view of the actuating mechanism 8 from FIG. 12. It can be seen in this view that the transverse strut 12 and therefore the two locking struts 11 are prestressed in the direction of the non-actuating position of the actuating lever 9 by a first spring element 13, and the two locking pins 7 are each prestressed in the direction of the position protruding from the armrest 3 by a second spring element 14.

The vehicle console that is shown and described herein is not restricted to the embodiments disclosed herein, but also comprises further embodiments of identical effect. In one embodiment, the vehicle console is used in a motor vehicle, wherein the vehicle console is a center console arranged between a driver's seat and a front passenger's seat of the motor vehicle.

It should be pointed out that the features listed individually in the description herein can be combined with one another in any technically expedient manner and present further refinements of the invention. The description additionally characterizes and gives details of the invention, in particular in conjunction with the figures.

Spatially relative terms used herein, such as “top,” “bottom,” “front” or “rear” should be understood as meaning with respect to a vehicle console installed in a vehicle, wherein “top” denotes an orientation in the direction of the vehicle roof, “bottom” denotes an orientation in the direction of the vehicle floor, “front” denotes an orientation in the direction of the front of the vehicle and “rear” denotes an orientation in the direction of the rear of the vehicle. Furthermore, the longitudinal direction of the vehicle console should be understood here as meaning an orientation in the direction of the longitudinal axis of the vehicle, whereas a transverse direction of the vehicle console corresponds to an orientation in the direction of the transverse axis of the vehicle.

According to one embodiment, a vehicle console comprises a console body and an adjustable armrest. A storage compartment is provided in the console body, which storage compartment is accessible through an opening in an upper part of the console body. Furthermore, the armrest is held displaceably on a basic body which, in turn, is mounted pivotably on the console body. The armrest or the basic body is pivotable between a first pivoting position, in which the basic body extends along the opening of the storage compartment, and a second pivoting position, in which the basic body extends in an inclined manner with respect to the opening of the storage compartment. According to one embodiment, at least one guide is provided in the upper part of the console body in a direction extending in a longitudinal direction of the opening. Furthermore, at least one locking element which is displaceable together with the armrest along the basic body, protrudes from the armrest, but is retractable into the armrest by an actuating mechanism arranged on the armrest. According to one embodiment, the at least one guide is arranged on an inner side of the storage compartment in the console body, and, in the first pivoting position of the basic body, the at least one locking element, in its position protruding from the armrest, is guided in a sliding manner on the inner side of the storage compartment in the longitudinal direction of the opening of the storage compartment by the guide.

Since the guide is provided on the inner side of the storage compartment, of the guide or locking mechanism of the armrest on the console body only the locking element, which is held on the armrest, can still be seen in its position protruding from the latter, as viewed from the outside, which enables a considerably improved visual design of the vehicle console since a very substantially concealed integration of the guide or locking mechanism in the vehicle console according to the disclosure is possible. Furthermore, in the case of the vehicle console according to the disclosure, the armrest no longer has to completely engage around the console body, and in particular the guide on the console body, in its width, and therefore an overall more attractive design of the vehicle console can be achieved, in which the width of the armrest can substantially correspond to the width of the console body. Fracturing of the lower side of the armrest, for example due to incisions for accommodating the guide of the console body in the closed state of the vehicle console can likewise be avoided.

According to one embodiment, the guide is designed as a one-sided guide rail on the upper part of the console body, in particular of the storage compartment, on which the at least one locking element is guided merely on one side. In other words, in the first pivoting position of the armrest or of the basic body, on which the armrest is held in a sliding manner, the locking element engages behind the guide rail and is guided merely on one side on the latter. This makes it possible for a guide of the locking element on the guide rail to be realized in a mechanically simple manner, to be tolerant in respect of the accuracy of joining guide rail and locking element and therefore also to be produced cost-effectively. Consequently, a guide groove with a two-sided guide of the locking element by the two side walls of the groove can be dispensed with.

An advantageous refinement of the vehicle console provides that the one-sided guide rail is designed in the form of a flange on an upper edge of the console body. Therefore, the upper edge of the console body has, at least in the portion of the opening of the storage compartment, an upper edge which is curved with respect to the inner side of the storage compartment and along which the locking element is guided in a sliding manner. In addition to being able to be produced in a simple manner, the profile of the upper edge in the form of a flange advantageously additionally provides stiffening of the console body in the region of its upper part and therefore of the storage compartment accommodated in the console body.

For the further advantageous simplification of the production of the vehicle console and an associated reduction in costs, a further advantageous refinement of the vehicle console provides that the guide, for example the one-sided guide rail in the form of a flange, is formed integrally with the console body. In particular, the guide can be injection molded in a manner known per se, for example, onto a console body produced from plastic.

According to yet another advantageous refinement, in the first pivoting position of the basic body, the armrest is prestressed elastically in the direction of the second pivoting position of the basic body. In other words, in the closed state closing the storage compartment, the armrest is pushed in the direction of its open position (second pivoting position of the basic body), as a result of which the at least one locking element is always brought into contact with the guide, for example the one-sided guide rail. By this means, a tendency of the vehicle console to shake in the closed state can be significantly reduced in an advantageous manner. In addition, the armrest is fixed as desired in its longitudinal position by the frictional force, which is produced by the contact force, between the locking element and the guide. Only by overcoming the frictional force can the armrest be adjusted in its longitudinal direction into a new desired position along the guide. As a result, the operating comfort for a user of the vehicle console is considerably increased and the structural outlay on the vehicle console is significantly reduced.

The above-described prestressing of the armrest in the closed state can preferably be produced by the elasticity of the slightly compressed materials used for the production of the vehicle console, and therefore, for example, an additional spring element which could push the armrest or the basic body, on which the armrest is held in a longitudinally displaceable manner, from the first pivoting position into the second pivoting position can be dispensed with. However, such a spring element can also (additionally) be provided, if desired.

A further advantageous refinement of the vehicle console provides that the actuating mechanism is completely accommodated in a housing which is arranged on a lower side of the armrest facing the opening of the storage compartment, and the lower side of the housing facing the opening of the storage compartment is of smooth design. As a result, firstly, the production of the housing can be simplified, and also a visually more attractive design of the vehicle console can be achieved since the lower side of the armrest is not fractured by incisions accommodating the upper edge of the console body, as is the case, for example, when a guide groove and the locking element are arranged on the outer side of the console body.

According to yet another advantageous refinement of the vehicle console, the actuating mechanism comprises an actuating lever mounted on the armrest so as to be rotatable between a non-actuating position and an actuating position, at least one locking strut mounted in a longitudinally displaceable manner in the longitudinal direction of the armrest, and the transversely displaceable at least one locking element which is designed as a locking pin in the transverse direction of the armrest. The actuating lever interacts with the locking strut in such a manner and the locking strut interacts in turn with the locking pin in such a manner that rotation of the actuating lever brings about a longitudinal displacement of the locking strut, which, in turn, brings about a transverse displacement of the locking pin. The transverse displacement of the locking pin leads either to engagement of the locking pin with the guide formed on the console body (in the case of the position of the locking element protruding from the armrest), such that the armrest closes the storage compartment, or to opening up the guide (in the position of the locking element retracted into the armrest), such that the armrest can be pivoted together with the basic body and therefore the storage compartment opened.

The at least one locking strut can preferably be spring-loaded in the direction of the non-actuating position of the actuating lever. Similarly, the at least one locking pin can be spring-loaded in the direction of the position protruding from the armrest. This permits an actuating mechanism which can be realized in a mechanically simple manner, is comfortable to operate and in which only the opening up of the lock in order to open the storage compartment requires an actuating effort. The closing of the storage compartment by swinging down the armrest onto the console body and the associated production of the engagement between the guide and the locking element can take place automatically.

The disclosure provides a vehicle console which is improved both mechanically and in respect of the visual design, has an adjustable armrest and in which the armrest can be pivoted by an actuating mechanism, which moves together with the armrest and is simple to operate, for opening up a storage compartment accommodated in a console body, and can additionally also be adjusted in its longitudinal direction. In particular, the guide or locking mechanism of the armrest on the console body is very substantially integrated in a concealed manner in the vehicle console and is therefore substantially not visible, as seen from the outside, which permits a visually attractive design of the vehicle console. In addition, the vehicle console can be produced cost-effectively.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle console comprising:
a console body defining a storage compartment which is accessible through an opening in an upper part of the console body;
an armrest held displaceably on a basic body which is mounted pivotably on the console body to be pivotable between a first pivoting position, in which the basic body extends along the opening, and a second pivoting position, in which the basic body is inclined with respect to the opening;
at least one guide provided in the upper part of the console body extending in a longitudinal direction of the opening; and
at least one locking element which is displaceable together with the armrest along the basic body, protrudes out of the armrest and is retractable into the armrest by an actuating mechanism arranged on the armrest, wherein the at least one guide is arranged on an inner side of the storage compartment in the console body, and, in the first pivoting position of the basic body, the at least one locking element, in its position protruding from the armrest, is guided in a sliding manner on the inner side of the storage compartment in the longitudinal direction of the opening by the guide, wherein the at least one guide is designed as a one-sided guide rail on the upper part of the console body, on which the at least one locking element is guided only on one side.

2. The vehicle console as claimed in claim 1, wherein the one-sided guide rail is designed in the form of a flange on an upper edge of the console body.

3. The vehicle console as claimed in claim 1, wherein the at least one guide is formed integrally with the console body.

4. The vehicle console as claimed in claim 1, wherein in the first pivoting position of the basic body, the armrest is prestressed elastically in a direction of the second pivoting position of the basic body.

5. The vehicle console as claimed in claim 1, wherein the actuating mechanism is completely accommodated in a housing which is arranged on a lower side of the armrest facing the opening of the storage compartment, and the lower side of the housing facing the opening of the storage compartment is of smooth design.

6. The vehicle console as claimed in claim 1, wherein the actuating mechanism comprises an actuating lever mounted on the armrest to be rotatable between a non-actuating position and an actuating position, at least one locking strut mounted in a longitudinally displaceable manner in the longitudinal direction of the armrest, and the at least one locking element which is designed as a locking pin in a transverse direction of the armrest, wherein the actuating lever interacts with the locking strut which interacts with the locking pin in such a manner that rotation of the actuating lever brings about a longitudinal displacement of the locking strut which brings about a transverse displacement of the locking pin.

7. The vehicle console as claimed in claim 1, wherein the at least one locking strut is spring-loaded in a direction of the non-actuating position of the actuating lever, and the at least one locking pin is spring-loaded in a direction of the position protruding from the armrest.

8. A vehicle console comprising:
a console body defining a storage compartment and an upper opening;
an armrest held displaceably on a basic body which pivots on the console body between first and second pivoting positions;
a guide provided in an upper part of the console body; and
a locking element displaceable together with the armrest along the basic body to protrude out and retract into the armrest by an actuating mechanism.

9. The vehicle console as claimed in claim 8, wherein the guide is designed as a one-sided guide rail on the upper part of the console body, on which the locking element is guided only on one side.

10. The vehicle console as claimed in claim 9, wherein the one-sided guide rail is designed in the form of a flange on an upper edge of the console body.

11. The vehicle console as claimed in claim 9, wherein the guide is arranged on an inner side of the storage compartment in the console body, and, in the first pivoting position of the basic body, the locking element, in its position protruding from the armrest, is guided in a sliding manner on the inner side of the storage compartment in a longitudinal direction of the opening by the guide.

12. The vehicle console as claimed in claim 8, wherein the basic body extends along the opening in the first pivoting position and the basic body is inclined with respect to the opening in the second pivoting position.

13. The vehicle console as claimed in claim 8, wherein the guide is formed integrally with the console body.

14. The vehicle console as claimed in claim 8, wherein in the first pivoting position of the basic body, the armrest is prestressed elastically in a direction of the second pivoting position of the basic body.

15. The vehicle console as claimed in claim 8, wherein the actuating mechanism is completely accommodated in a housing which is arranged on a lower side of the armrest facing the opening of the storage compartment, and the lower side of the housing facing the opening of the storage compartment is of smooth design.

16. The vehicle console as claimed in claim 8, wherein the actuating mechanism comprises:
an actuating lever mounted on the armrest to be rotatable between a non-actuating position and an actuating position; and
a locking strut mounted in a longitudinally displaceable manner in a longitudinal direction of the armrest, and the locking element which is designed as a locking pin in a transverse direction of the armrest, wherein the actuating lever interacts with the locking strut which interacts with the locking pin in such a manner that rotation of the actuating lever brings about a longitudinal displacement of the locking strut, which brings about a transverse displacement of the locking pin.

17. The vehicle console as claimed in claim 8, wherein the locking strut is spring-loaded in a direction of the non-actuating position of the actuating lever, and the locking pin is spring-loaded in a direction of the position protruding from the armrest.

18. A vehicle console comprising:
a console body defining a storage compartment and an upper opening;
an armrest held displaceably on a basic body which pivots on the console body between first and second pivoting positions;
a one-sided guide rail provided on an upper part of the console body; and
a locking element displaceable together with the armrest along the basic body and guided only on one side of the guide rail.

19. The vehicle console as claimed in claim 18, the locking element protrude out of the armrest and is retractable into the armrest by an actuating mechanism arranged on the armrest.

20. The vehicle console as claimed in claim 19, wherein the guide is arranged on an inner side of the storage compartment in the console body, and, in the first pivoting position of the basic body, the at least one locking element, in its position protruding from the armrest, is guided in a sliding manner on the inner side of the storage compartment in a longitudinal direction of the opening by the guide.
